(19) United States
(12) Patent Application Publication
(10) Pub. No.: US 2006/0178810 A1
(43) Pub. Date: Aug. 10, 2006

(54) Navigation system

(75) Inventors: Saburo Hashima, Kuwana-city (JP); Shinichi Iwai, Ichinomiya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/348,263

(22) Filed: Feb. 7, 2006

(30) Foreign Application Priority Data
Feb. 10, 2005 (JP) 2005-034825

(51) Int. Cl. G01C 21/36

(52) U.S. Cl. 701/200

(57) ABSTRACT

A navigation system in a subject vehicle for organizing a navigation route having a blind alley toward a destination in map data as a route guidance by using a node and a link includes a blind alley detection means for detecting the blind alley in the navigation route, and a blind alley specific instruction means for providing a blind alley specific instruction upon detecting the blind alley. The subject vehicle is navigated to travel in reverse for one of entrance into and departure from the blind alley according to the route guidance.

### CROSS REFERENCE TO RELATED APPLICATION

This application is based on and claims the benefit of priority of Japanese Patent Application No. 2005-34825 filed on Feb. 10, 2005, the disclosure of which is incorporated herein by reference.

### FIELD OF THE INVENTION

The present invention generally relates to a navigation system.

### BACKGROUND OF THE INVENTION

Conventionally, a navigation system for use in a subject vehicle provides navigation instructions for a driver that includes driving instruction for a road having a blind alley, a cul-de-sac or the like, i.e., a street having a closed end without circular area for turning,. when a navigation route toward a destination has that type of roads. For example, Japanese Patent Document JP-A-H10-227649 discloses the navigation system having a function of providing a navigation route that has a U-turn path contained therein when the vehicle enters into the blind alley. The navigation system searches for and organizes a navigation route including a U-turn path whose course spans from a next node in a traveling direction of the subject vehicle to a preceding node in the route when a U-turn search button is pressed by a driver.

The navigation system described above is capable of navigating the vehicle through a blind alley or the like. However, the navigation system does not provide any navigation instruction when the destination of the navigation route is a blind alley regardless of the convenience of the driver of the vehicle. That is, the driver of the vehicle may prefer a certain manner of entering into a blind alley, because the manner, i.e., a direction of the vehicle in the blind alley, of entering into the blind alley affects an “escape” route or a departure route from the blind alley. For example, some drivers may prefer entering into a blind alley head-on by forward travel, while other drivers may prefer backing into the blind alley by reverse travel.

### SUMMARY OF THE INVENTION

In view of the above-described and other problems, the present invention provides a navigation system that can give navigation instructions for a blind alley to a user in a subject vehicle when the blind alley is included in a navigation route.

A first aspect of the present invention provides a navigation system for use in the subject vehicle that includes a blind alley detection function for detecting a blind alley in a navigation route, and a blind alley specific instruction function for providing a blind alley specific instruction upon detecting the blind alley. In this manner, the user in the subject vehicle can recognize the blind alley that exists at the end of the navigation route.

Another aspect of the present invention provides the navigation system that includes a blind alley warning function in the blind alley specific instruction function for providing a blind alley warning prior to an entrance into the blind alley. In this manner, the user can recognize the blind alley before the subject vehicle actually enters into the blind alley.

Yet another aspect of the present invention provides the navigation system that includes an entrance manner specification function for specifying a manner of entering into the blind alley. In addition, the blind alley specific instruction function includes a blind alley entrance instruction function for providing an instruction for entrance into the blind alley based on the manner defined by the entrance manner specification function. Therefore, the user can specify a specific manner of entering into the blind alley.

Still yet another aspect of the present invention provides the navigation system that includes a map data storage function for storing map data having node information for designating attribute of a node including connection of a node to a link together with link information for designating linkage of each link with the node. In this manner, the user can recognize the blind alley included in the navigation route.

Still yet anther aspect of the present invention provides the navigation system that includes the map data storage function for storing a blind alley flag as the attribute of the node in the node information for designating that the node has the link corresponding to the blind alley. In addition, the blind alley detection function detects the blind alley in the navigation route based on the blind alley flag stored in the node attribute information. In this manner, the navigation system can detect the blind alley by searching the blind alley flag.

Still yet another aspect of the present invention provides the navigation system that includes the map data storage function for storing connecting link information in the node information for designating a connecting link to the node, and the blind alley detection function for detecting the blind alley when the node with an entrance link has no departure link therefrom. In this manner, the navigation system can detect the blind alley based on the existence of the departure link.

Still yet another aspect of the present invention provides the navigation system that includes a crosscut detection function for detecting necessity of crosscut operation of the subject vehicle when the subject vehicle enters into the blind alley, and the blind alley entrance instruction function for providing the instruction for entrance into the blind alley by reverse travel regardless of the manner specified by the entrance manner specification function when necessity of the crosscut operation is detected by the crosscut detection function. In this manner, the user can avoid the crosscut operation of the subject vehicle when the subject vehicle enters into the blind alley by readily backing the subject vehicle into the blind alley.

Still yet anther aspect of the present invention provides the navigation system that includes the map data storage function for storing a width of the road in the link information, and the crosscut detection function for detecting necessity of the crosscut operation based on the width of the blind alley and a minimum turning radius of the subject vehicle. In this manner, the user can readily prepare the direction of the subject vehicle in a suitable manner for smooth departure from the blind alley.

Still yet another aspect of the present invention provides the navigation system that provides the instruction for entrance into the blind alley by reverse travel that is controlled by the existence of a center line on a road being connected to the blind alley.

The following situation explains the instruction used for the entrance into the blind alley. That is, the blind alley can be entered into from an adjacent road by simple reverse travel as shown in FIG. 5B. However, a U-turn of the subject vehicle is required before the entrance when the adjacent road is divided into two lanes by the center line as shown in FIG. 6B. Therefore, the navigation system of the present invention provides the instruction for the entrance into the blind alley based on the existence of the center line in the adjacent road.

Still yet another aspect of the present invention provides the navigation system that includes the blind alley entrance instruction function for providing the instruction for entrance into the blind alley by forward travel regardless of the manner of entering into the blind alley specified by the entrance manner specification function when the subject vehicle traveling in a road leading to the blind alley has another vehicle approaching from behind. In this manner, risk of rear-end collision is reduced.

Still yet another aspect of the present invention provides the navigation system that includes a blind alley departure instruction function in the blind alley specific instruction function for providing an instruction for departure from the blind alley based on the manner used for the entrance into the blind alley when the subject vehicle is stopping at the end of the blind alley. In this manner, the navigation system can suitably provide departure instruction for the subject vehicle. That is, the departure instruction by forward travel is provided for the vehicle that has entered into the blind alley by reverse travel, and the departure instruction by reverse travel is provided for the vehicle that has entered into the blind alley by forward travel.

Still yet another aspect of the present invention provides the navigation system that includes a display controlling function in the blind alley specific instruction function for displaying a map of the navigation route with the blind alley. In this manner, the user can recognize positional relationship between the blind alley, a passing point and the destination in the navigation route.

### BRIEF DESCRIPTION OF THE DRAWINGS

Other objects, features and advantages of the present invention will become more apparent from the following detailed description made with reference to the accompanying drawings, in which:

FIG. 1 shows a block diagram of a navigation system in an embodiment of the present invention;

FIG. 2 shows an example of an user interface for configuration of the navigation system;

FIG. 3 shows a flowchart of a blind alley determination process;

FIGS. 4A to 4C show navigation instructions for approaching a destination located at the end of a blind alley;

FIGS. 5A to 5C show navigation instructions for approaching the destination located at the end of the blind alley from a connecting road without a centerline by reverse travel;

FIGS. 6A to 6C show navigation instructions for approaching the destination located at the end of the blind alley from the connecting road with the centerline by reverse travel;

FIG. 7A shows navigation instructions for departure from the destination located at the end of the blind alley toward a direction A and a direction C;

FIG. 7B shows navigation instructions for departure from the destination at the end of the blind alley toward a direction B; and

FIG. 8 shows an expanded view of an intersection having a blind alley.

### DETAILED DESCRIPTION OF THE PREFERRED EMBODIMENTS

An embodiment of the present invention is described with reference to the drawings. A navigation system of the present invention is intended for use in a subject vehicle such as an automobile or the like.

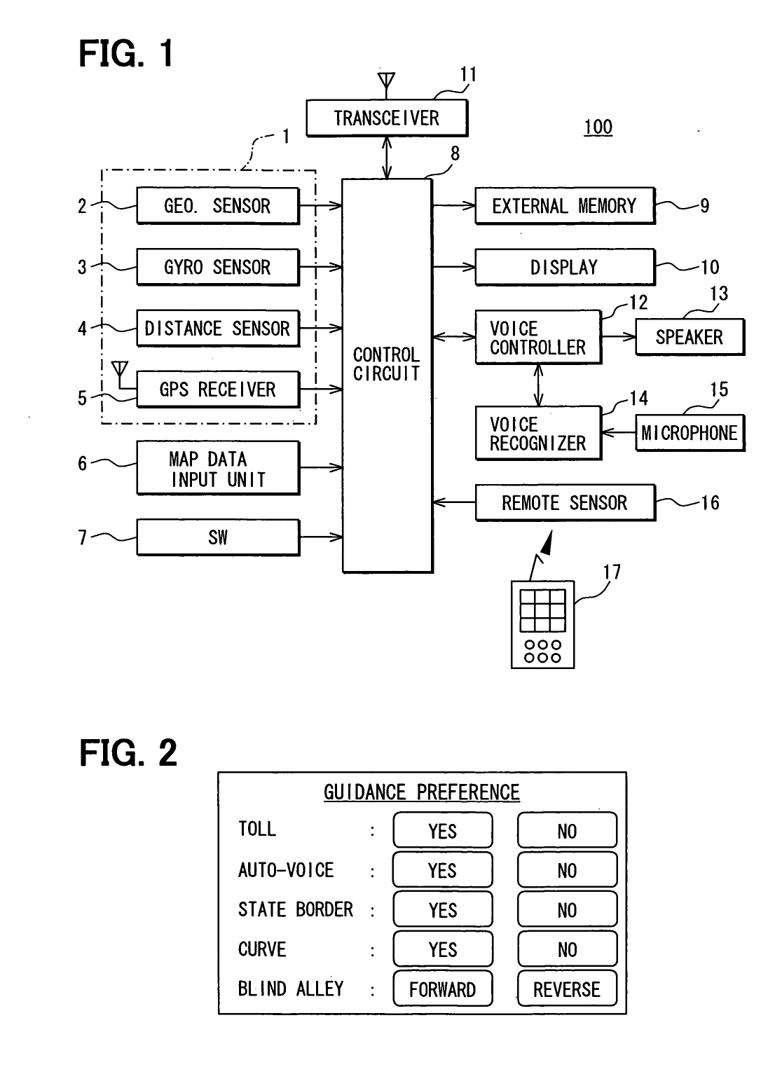

FIG. 1 shows a block diagram of the navigation system in the embodiment of the present invention. The navigation system 100 includes a position detector 1, a map data input unit 6, operation switches 7, an external memory 9, a display 10, a transceiver 11, a voice controller 12, a speaker 13, a voice recognizer 14, a microphone 15, a remote controller sensor 16, a remote controller 17, and a control circuit 8 for controlling those devices.

The control circuit 8 is a computer of well-known type, and includes a CPU, a ROM, a RAM, an I/O and a bus line for interconnection between these devices (not shown in the figure). The control circuit 8 processes information from the position detector 1, the map data input unit 6, the operation switches 7, the external memory 9, the display 10, the transceiver 11, the voice controller 12, the speaker 13, the voice recognizer 14 and the remote controller sensor 16 to execute various processes of, for example, map scaling, menu display, destination setting, route search, route guidance, position correction, display switching, volume control and the like.

The position detector 1 includes a plurality of sensors such as a geomagnetism sensor 2, a gyro sensor 3, a distance sensor 4, a Global Positioning System (GPS) receiver 5 and the like. The GPS receiver 5 is used to determine a current position of the subject vehicle based on a signal from GPS satellites. These sensors are complementarily used for interactive compensation of errors of respectively different natures. These sensors may selectively be used based on the accuracy of the output, and a steering rotation sensor, a speed sensor or the like (not shown in the figure) may further be utilized.

The map data input unit 6 is used to input map data such as road network data, index data, drawing data or the like into the navigation system under instructions from the control circuit 8. These data are provided in various kinds of memory medium such as a CD-ROM, a DVD-ROM as well as a writable medium such as a memory card, a hard disk or the like.

Next, links and nodes in the road network data are described. Links and nodes are defined as a geometrical element with two points attached on both ends of the element, and the node corresponds to a crossing, a branch point or the like of a road. Roads in a real world are geometrically represented by using the links and nodes. Link data includes a link ID, a link length, coordinates (e.g., latitude and longitude) of nodes on both ends, road name, road type (interstate, state road, local road, or the like), road width, travel time (time required for travel by car, on foot etc.) and the like.

Node data includes a node ID, node coordinate (e.g., latitude and longitude), connecting link IDs for designating all the links that share the node as an end point, and node attribute that designates a node type such as an intersection, a branch point or the like. The node attribute further includes a blind alley flag that designates that the connecting link to the node is a representation of a blind alley. In other words, the blind alley flag indicates that the node has only one connecting link.

The index data is used for searching facilities or the like stored in the map data. The index data includes a name of, for example, a facility, a road, an intersection and the like as well as a facility type, an address, a telephone number, coordinates (latitude and longitude) and the like.

The drawing data is used to draw a map. The drawing data includes shapes of the geographical features such as a sea, a lake, a pond, a mountain as well as display information on, for example, a facility, a road, a crossing, a branch point or the like. The display information includes attributes of display object (the facility, the road etc.) such as text for representing name of the display object, display position (coordinates) of the object, polygon data, icon data (landmark sign or the like).

The operation switches 7 are, for example, disposed as touch switches or mechanical switches on the display 10, and are used for inputting various kinds of instruction for the control circuit 8. The instruction may include execution of processes such as map scaling, menu display, destination setting, route search, route guidance, position correction, display switching, volume control and the like.

The remote controller 17 also has a plurality of switches for inputting various types of instructions for the control circuit 8 through the remote controller sensor 16. The instructions from the remote controller 17 and from the operation switches 7 are compatible in terms of execution of processes or the like under control of the control circuit 8.

The navigation system 100 searches and displays an optimum route from a current position or a start point to a destination upon receiving an input of the destination through operation switches 7 and data on the current position from the position detector 1. The optimum route is found by using an algorithm such as Dijkstra method or the like. The optimum route may include a passing point specified between the start point and the destination.

The display 10 is, for example, a liquid crystal display or an organic EL display being capable of displaying a full range of colors, and displays a position mark at the current position derived from the position detector 1 on a map drawn by using the drawing data inputted from the map data input unit 6 together with the optimum route. The map on the display 10 may include a representation of current time, congestion information or other type of additional information.

The external memory 9 is a large scale memory unit such as a hard disk drive that stores data on a writable medium. The external memory 9 retains data while the navigation system 100 is turned off, and stores frequently used data copied inputted from the map data input device 6. The external memory 9 may be a small scale memory medium, or may be a removable medium.

The transceiver 11 receives information on, for example, traffic condition, weather forecast, facility location, advertisement or the like, and is also used to transmit vehicle information and user information to an external station or the like. The information received by the transceiver 11 is processed and delivered by using the control circuit 8.

The speaker 13 outputs guidance voice or the like based on a sound control signal from the voice controller 12. The guidance voice is used to provide display operation guidance, voice recognition result or the like. The microphone 15 is used to input user's voice to the voice recognizer 14 as an electric signal.

The voice recognizer 14 matches the user's voice and stored vocabulary in a dictionary by using the microphone 15, and outputs recognition result to the voice controller 12.

The voice controller 12 controls the voice recognizer 14, and provides a response to the input of the user's voice through the speaker 13. The voice controller 12 also provides recognition result by the voice recognizer 14 to the control circuit 8.

The control circuit 8 executes predetermined processes such as map scaling, menu display, destination setting, route search, route guidance, position correction, display switching, volume control or the like based on the recognition result and other information from the voice recognizer 14. The control circuit 8 outputs route guidance or the like from the speaker 13 through the voice controller 12.

The navigation system 100 executes a blind alley detection process for the navigation route prepared by route searching. The blind alley found in the process is notified to a user when the route guidance is started.

The blind alley is notified to the user at a predetermined distance together with an instruction of entrance into the blind alley. In this manner, the navigation system 100 provides information on the blind alley for the user before the subject vehicle actually enters into the blind alley.

Approach to the blind alley can be specified by using a user interface shown in FIG. 2. That is, the approach, or entrance manner into the blind alley can be specified either as “forward travel” or “reverse travel” by the user in the user interface. In this manner, the navigation system 100 provides the entrance manner instruction to the user based on the user's preference when the subject vehicle approaches the blind alley.

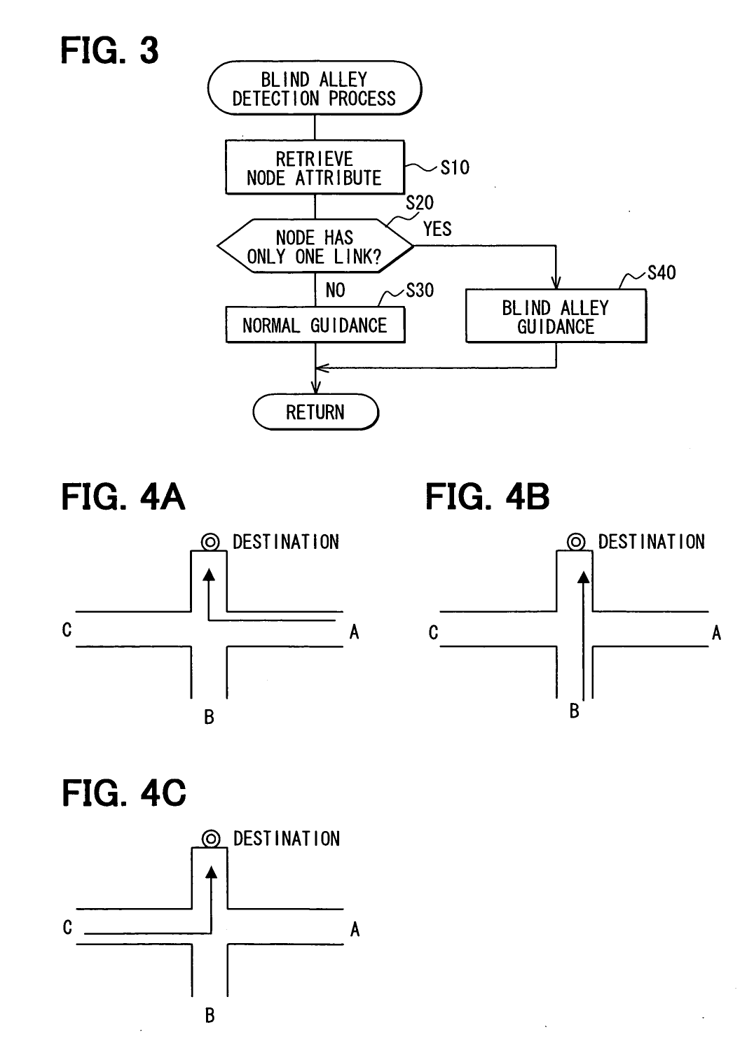

The navigation system 100 detects the blind alley in the navigation route by the process in a flowchart shown in FIG. 3. The process determines a node as an end point of a blind alley based on the map data including the node data and the link data. In the following description, the destination is exemplarily used as an object of the process for the blind alley detection, because the same process can be applicable for the passing point at the end of the blind alley in the navigation route.

The process starts with step S10 that retrieves node attribute of the destination derived from the route search.

In step S20, the process determines whether the node has only one link or more than one link. That is, the process determines whether the node has the blind alley flag in the node attribute. The process proceeds to step S40 to provide blind alley guidance in the route guidance when the node has only one link. The process proceeds to step S30 to provide normal guidance when the node has more than one link.

The node may be determined as an end point of the blind alley based on the existence of a departure link that corresponds to an entrance link. That is, the node may be determined as the end point of the blind alley when the entrance link does not have a matching departure link.

The blind alley detection process is followed by a blind alley notification process for notifying the blind alley for the user prior to the approach to the blind alley. For example, the blind alley notification process provides a destination mark or the like on the map in the display 10 for the user as well as the guidance voice for notifying that the destination is at the end of the blind alley. In this manner, the user can recognize that the destination exists at the end of the blind alley with visual assistance of the map.

The blind alley notification process is followed by a blind alley entrance guidance process. The blind alley entrance guidance process provides the guidance voice as well as the visual representation such as a mark on the map for entrance guidance into the blind alley in a same manner as the notification process.

The blind alley entrance guidance process provides the entrance guidance based on preference inputted by the user. Setting of the preference includes approach manner such as forward travel/reverse travel of the subject vehicle in the blind alley and direct entrance/U-turn entrance in accordance with attributes of a connecting road to the blind alley. The attributes of the connecting road includes existence of a center line or the like.

Various cases of entrance guidance are described with reference to the drawings.

FIGS. 4A to 4C show illustration of entrance guidance into the blind alley by forward travel from the connecting road based on forward travel preference setting. The entrance guidance on the map to the blind alley is provided as shown in FIGS. 4A to 4C. That is, the subject vehicle enters into the blind alley by forward travel from each of three directions A, B and C. In this manner, entrance guidance into the blind alley by forward travel is restricted only by traffic regulations regardless of existence of the center line in the connecting road.

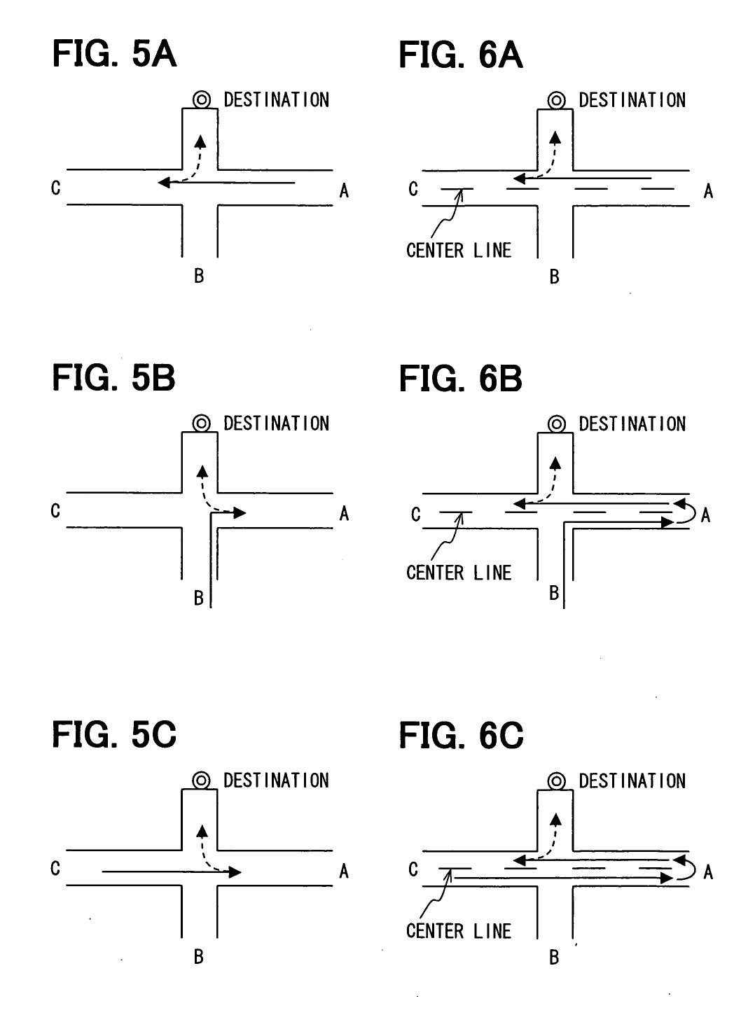

The entrance guidance for reverse travel into the blind alley is shown in FIGS. 5A to 5C, and 6A to 6C. In this case, the entrance guidance is provided in the following manner.

The entrance guidance for reverse travel from the direction A is shown in FIGS. 5A and 6A. The entrance guidance for reverse travel from the direction A is always in a same manner regardless of the existence of the center line in the connecting road, only abiding by traffic regulations. The guidance voice for the reverse travel may sound “The destination is located in a blind alley. Please exercise caution when traveling in reverse.”

The entrance guidance for reverse travel from the direction B is shown in FIGS. 5B and 6B. The entrance guidance from the direction B is different depending on the type of the road. That is, the entrance guidance from the direction B is reverse travel after right turn when the connecting road does not have the center line, and is reverse travel after passing the blind alley with a preceding right turn and U-turn. In this case, the entrance guidance may be provided as left turn followed by reverse travel. However, the right turn is used in view of a reduced risk of rear end collision with another vehicle approaching from behind.

The entrance guidance for reverse travel from the direction C is shown in FIGS. 5C and 6C. The entrance guidance from the direction C is also different depending on the type of the road. That is, the entrance guidance from the direction C is simply provided as reverse travel after passing the blind alley as shown in FIG. 5C when the connecting road does not have the center line, and is provided as reverse travel after passing the blind alley with a preceding U-turn as shown in FIG. 6C when the connecting road has the center line. The guidance voice may sound “The destination is located in a blind alley. Pass the alley for entrance in reverse.”

The entrance guidance for the blind alley is respectively differently provided depending on the type of the connecting road for optimum safety and convenience of the user.

The navigation system 100 provides blind alley related guidance such as blind alley notification, blind alley entrance or the like based on preference setting by the user when the navigation route to the destination includes a blind alley. In this manner, the user can recognize the blind alley included in the course of travel to the destination for improved convenience of driving operation or the like.

### Modification 1

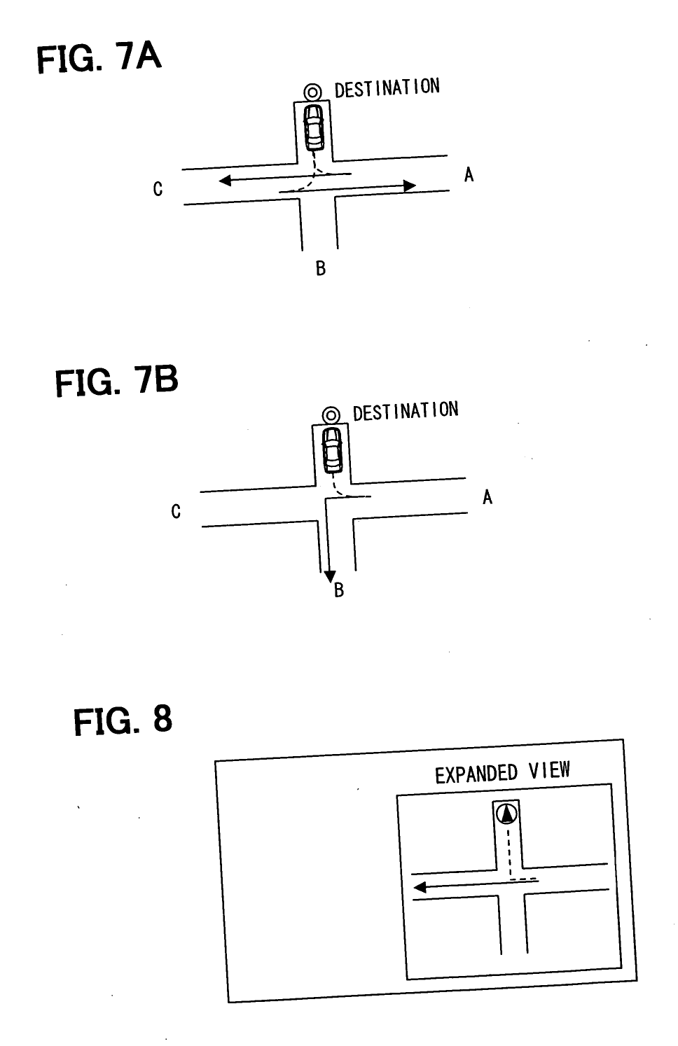

The navigation system 100 may be used to provide guidance for departure from the blind alley. The user in the subject vehicle benefits from the guidance for departure especially when the vehicle departs from the blind alley by reverse travel. For example, the guidance for departure from the blind alley is provided for the subject vehicle that entered into the blind alley by forward travel in a manner shown in FIGS. 7A and 7B. That is, the guidance for departure by reverse travel is provided in the manner shown in FIG. 7A for the subject vehicle departing in a direction A or in a direction C, and the guidance for departure by reverse travel is provided for the subject vehicle departing in a direction A or in a direction C in the manner shown in FIG. 7B for the subject vehicle departing in a direction B. The guidance in FIGS. 7A and 7B is accompanied by an expanded view of illustration of reverse travel as shown in FIG. 8.

In this manner, the navigation system 100 can appropriately provide the departure guidance for the subject vehicle departing from the blind alley depending on the direction of travel. Further, the navigation system 100 may provide information on an approaching vehicle traveling on the connecting road. The information on the approaching vehicle may be acquired through communication by the transceiver 11 or from a radar disposed on a rear side of the vehicle.

### Modification 2

The navigation system 100 may manage a following vehicle from behind the subject vehicle by providing forward travel entrance guidance into the blind alley for reducing a risk of rear end collision. That is, for example, the subject vehicle may closely encounter the following vehicle while traveling in reverse because of the opposing traveling directions of both vehicles at the proximity of the blind alley. Therefore, the navigation system 100 may provide forward travel entrance guidance into the blind alley in an occasion that the subject vehicle is followed by another vehicle at the proximity of the blind alley regardless of the preference setting. In this manner, the navigation system 100 reduces a risk of rear end collision in a course of providing the guidance.

### Modification 3

The navigation system 100 may provide specific guidance for entrance into a narrow blind alley by forward travel based on necessity of crosscut operation of the subject vehicle. The specific guidance is provided for the user in order to avoid the crosscut operation at the cost of user's convenience.

The navigation system 100 determines the necessity of the crosscut operation based on calculation by using the width of the blind alley, the width of the connecting road and the minimum turn radius of the subject vehicle. That is, a size of an area available for turning into the blind alley and a size of an area required for turning of the subject vehicle are compared for determination.

The navigation system 100 provides the guidance for entrance into the blind alley by reverse travel against the preference setting of forward travel when the available area is smaller than the required area. In this manner, necessity of the crosscut operation when turning into the blind alley can be recognized prior to entrance. In this case, the minimum turn radius of the subject vehicle may be stored in the external memory 9.

Although the present invention has been fully described in connection with the preferred embodiment thereof with reference to the accompanying drawings, it is to be noted that various changes and modifications will become apparent to those skilled in the art.

For example, the blind alley may be interpreted as a very narrow road where the vehicle has to be maneuvered to get out, or the vehicle has to be driven in reverse due to a maze-like situation. That is, the blind alley may not necessarily be a dead-end road but a road that is impassable due to its narrowness or the like.

Such changes and modifications are to be understood as being within the scope of the present invention as defined by the appended claims.

What is claimed is:

1. A navigation system in a subject vehicle for organizing a navigation route having a blind alley toward a destination in map data as a route guidance by using a node and a link comprising:
a blind alley detection means for detecting the blind alley in the navigation route; and
a blind alley specific instruction means for providing a blind alley specific instruction upon detecting the blind alley,
wherein the subject vehicle is navigated to travel in reverse for one of entrance into and departure from the blind alley according to the route guidance.

2. The navigation system according to claim 1 further comprising:
a blind alley notification unit in the blind alley specific instruction means for providing a blind alley notification prior to entrance into the blind alley.

3. The navigation system according to claim 2 further comprising:
an entrance manner specification means for specifying a manner of entering into the blind alley; and
a blind alley entrance instruction unit in the blind alley specific instruction means for providing an instruction for entrance into the blind alley based on the manner specified by the entrance manner specification means.

4. The navigation system according to claim 3 further comprising:
a map data storage means for storing map data that includes node information for designating node attribute including connection of the node to the link together with link information for designating linkage of the nodes by the link.

5. The navigation system according to claim 4,
wherein the map data storage means stores a blind alley flag as the node attribute in the node information for designating that the node has the link corresponding to the blind alley, and
the blind alley detection means detects the blind alley in the navigation route based on the blind alley flag stored in the node attribute.

6. The navigation system according to claim 4,
wherein the map data storage means stores connecting link information in the node information for designating a connecting link to the node, and
the blind alley detection means detects the blind alley when the node with an inbound link has no outbound link.

7. The navigation system according to claim 6 further comprising:
a crosscut detection means for detecting necessity of crosscut operation of the subject vehicle when the subject vehicle enters into the blind alley,
wherein the blind alley entrance instruction unit provides the instruction for entrance into the blind alley by reverse travel regardless of the manner specified by the entrance manner specification means when necessity of the crosscut operation is detected by the crosscut detection means.

8. The navigation system according to claim 7,
wherein the map data storage means stores a road width in the link information, and
the crosscut detection means detects necessity of the crosscut operation based on the road width of the blind alley and a minimum turn radius of the subject vehicle.

9. The navigation system according to claim 8,
wherein the instruction for entrance into the blind alley by reverse travel differs depending on existence of a center line of a road being connected to the blind alley.

10. The navigation system according to claim 9,
wherein the blind alley entrance instruction unit provides the instruction for entrance into the blind alley by forward travel regardless of the manner of entering into the blind alley specified by the entrance manner specification means when the subject vehicle traveling on a road leading to the blind alley has another vehicle approaching from behind.

11. The navigation system according to claim 10 further comprising:
a blind alley departure instruction unit in the blind alley specific instruction means for providing an instruction for departure from the blind alley based on the manner of entering into the blind alley when the subject vehicle is at the end of the blind alley.

12. The navigation system according to claim 11 further comprising:
a display controlling unit in the blind alley specific instruction means includes for displaying a map of the navigation route having the blind alley.
